(19) United States
(12) Patent Application Publication
(10) Pub. No.: US 2025/0265107 A1
(43) Pub. Date: Aug. 21, 2025

(54) INTERRUPT MODERATION ONLOAD FOR ACCELERATED DATA PATHS

(71) Applicant: MELLANOX TECHNOLOGIES, LTD., Yokneam (IL)

(72) Inventor: Parav Kanaiyalal Pandit, Bangalore (IN)

(21) Appl. No.: 18/624,679

(22) Filed: Apr. 2, 2024

(30) Foreign Application Priority Data
Feb. 16, 2024 (IN) 202411011102

(51) Int. Cl. G06F 9/455

(52) U.S. Cl. CPC G06F 9/45558; G06F 2009/45575; G06F 2009/45579

(57) ABSTRACT

Systems and methods herein are for use with a Virtio standard and include at least one circuit to host a virtualizer component that enables different virtual machines (VMs), an accelerator driver, and a virtualizer interrupt moderation library, where the accelerator driver can be associated with an accelerator device. The accelerator driver can monitor interrupts associated with the different VMs to determine at least a current interrupt value and packet statistics that may be used by the virtualizer interrupt moderation library as a basis to provide an intended interrupt value to be used by the accelerator device for managing further interrupts to the different VMs.

### CROSS-REFERENCE TO RELATED APPLICATIONS

This application is related to and claims the benefit of priority from Indian Patent Application number 202411011102, filed on Feb. 16, 2024, and titled INTERRUPT MODERATION ONLOAD FOR ACCELERATED DATA PATHS, the disclosure of which is incorporated by reference herein in its entirety for all intents and purposes.

### TECHNICAL FIELD

At least one embodiment pertains to managing interrupt moderation that may include onloads for interrupts between circuits in a computing environment.

### BACKGROUND

Interrupt moderation may be provided by different schemes including some performed by independent guest drivers in a computing environment. The computing environment may include virtual machines (VMs). However, in such schemes, interrupt moderation may include parameters that are to be updated in a host memory and updated asynchronously to a device memory. As such, a device having the device memory may be unaware of such updates. The device may need to periodically read values of those parameters or may need to read parameters in a critical data path associated with where interrupt generation occurs. Such reading of parameters or values, over different communication fabrics, including peripheral component interconnect (PCI®), may slow an interrupt generation process or affect a packet processing flow. This represents at least one type of inefficiency in at least one of the schemes. A further inefficiency may occur as a result of race conditions that may be possible where indices associated with interrupt queues may be wrapped. The wrapping of indices may cause false interrupts or may cause interrupts to be delayed often. Yet another inefficiency may be associated with interrupt moderation which forces disabling the driver notifications from a driver to a device. For example, this process demands polling of thousands of indices by a device across hundreds to thousands of VMs. This may result in reads that reduce a device's ability to handle outstanding inputs and outputs and increases latency many folds as a device may be blind as to reading of queue notifications for new work items added to a queue, for instance. Further, interrupt moderation under certain schemes may need to be performed an up-to-date guest VM driver. However, when a VM does not have such a VM driver updated, it may not benefit from interrupt moderation.

### BRIEF DESCRIPTION OF DRAWINGS

FIG. 1 is an illustration of a Virtio standard system for improving management of interrupt moderation for interrupts between circuits in a computing environment, in at least one embodiment;

FIG. 2 is an illustration of further details of a Virtio standard system for improving management of interrupt moderation for interrupts between circuits in a computing environment, in at least one embodiment;

FIG. 3 is an illustration of details of the virtualizer component in a Virtio standard system for improving management of interrupt moderation for interrupts between circuits in a computing environment, in at least one embodiment;

FIG. 4 illustrates computer and processor aspects of a Virtio standard system for improving management of interrupt moderation for interrupts between circuits in a computing environment, in at least one embodiment;

FIG. 5 illustrates a process flow for a Virtio standard system for improving management of interrupt moderation for interrupts between circuits in a computing environment, in at least one embodiment;

FIG. 6 illustrates yet another process flow for a Virtio standard system for improving management of interrupt moderation for interrupts between circuits in a computing environment, in at least one embodiment;

FIG. 7 illustrates a further process flow for a Virtio standard system for improving management of interrupt moderation for interrupts between circuits in a computing environment, in at least one embodiment; and

FIG. 8 illustrates an exemplary data center and associated aspects to be used with a Virtio standard system for improving management of interrupt moderation for interrupts between circuits in a computing environment, in accordance with at least one embodiment.

### DETAILED DESCRIPTION

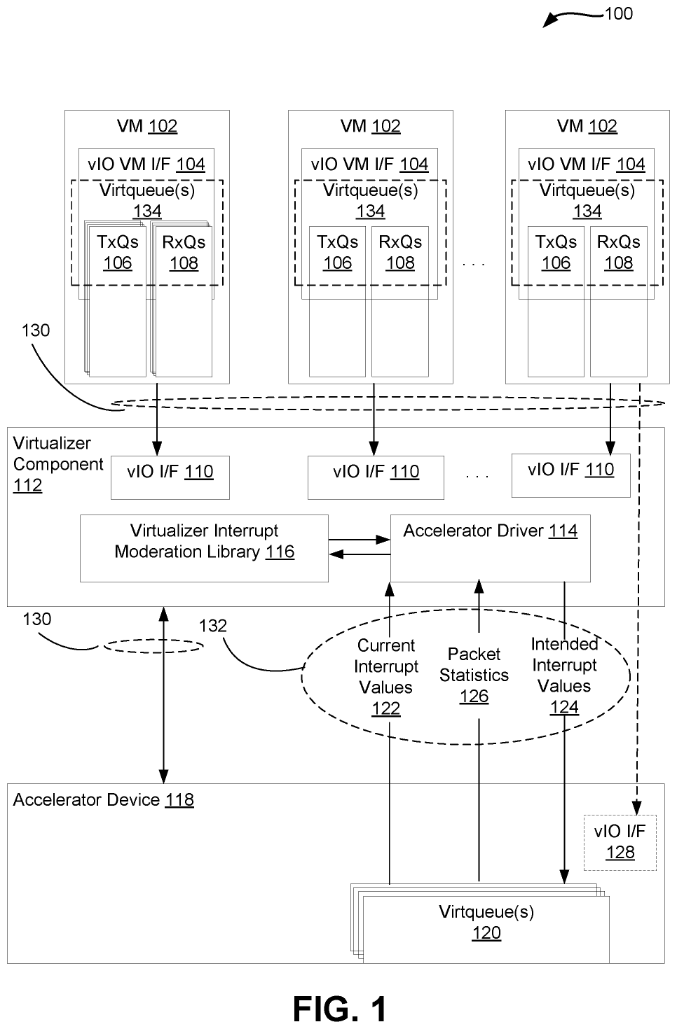

FIG. 1 is an illustration of a Virtio standard system 100 for improving management of interrupt moderation for interrupts between circuits in a computing environment, in at least one embodiment. As such, the system 100 herein can be used with Virtio standard input-output interfaces (vIO IFs), including for legacy vIO IFs that may be legacy Virtio® based devices from the Oasis® Open Standard Body. Management of interrupt moderation may include an onload procedure. As used herein, onload allows for a kernel bypass to be performed with respect to interrupt traffic or at least interrupt moderation, while also providing low latency in the system 100. The system 100 also enables centralized interrupt moderation that can address the aforementioned issues or inefficiencies. The onload procedure herein can reduce use of one or more circuits in a computing environment. The one or more circuits may be one or more processors or processing unit and may include execution units with the processors. The processors may include one or more of a central processing unit (CPU), a graphics processing unit (GPU), or a data processing unit (DPU).

The onload performed herein may be at least with respect to interrupt communications, by removing a need for the circuits herein to be involved in kernel-to-user interrupts. Applications with a virtual space can use virtual network devices to handle network calls without involving a kernel that may interface with a kernel interrupt moderation library. In the system 100 herein, the kernel's participation may be only as to supporting the virtualizer component 112. Instead of offloading the interrupt moderation logic or algorithm to an accelerator device, the system 100 herein onloads or reuses a kernel interrupt moderation library to provide interrupt moderation in association with a virtualizer component 112. This approach simplifies an accelerator device, in at least one embodiment.

Therefore, information about intended interrupt values for an accelerator driver 114 of a virtualizer component 112 may be provided from a virtualizer interrupt moderation library 116. The virtualizer interrupt moderation library 116 may be different from the kernel interrupt moderation library at least because the virtualizer interrupt moderation library 116 performs interrupt moderation for one or more virtqueues of the Virtio standard for the VMs 102, instead of queues that are owned by the kernel. The intended interrupt value may be based in part on a current interrupt value and packet statistics, and may be used in an accelerator device to manage one or more virtqueues to provide the interrupt moderation onload described herein. Further, the virtualizer interrupt moderation library 116 performs interpretation of the current interrupt values and of current packet statistics to determine if to provide an intended interrupt value for the system 100. In at least one embodiment, the packet statistics is provided by the accelerator device along with the current interrupt value. The packet statistics can include a packet rate, packet bytes or a number of packets, average packet size, or any other relevant statistics for traffic that may be more than interrupts.

Further, the system 100 being a Virtio standard system, requires features that are also Virtio standard. For example, the accelerator driver is necessarily a Virtio accelerator driver and the accelerator device is necessarily a Virtio accelerator device or a Virtio (or vhost) data path accelerator device, and the virtqueues herein are necessarily Virtio's virtqueues. The use of the virtualizer interrupt moderation library, along with the accelerator driver between an accelerator device and the virtualizer interrupt moderation library, provide information about intended interrupt values in a scheme for onload of interrupt moderation that beneficially address the inefficiencies described herein. For example, the interrupt moderation herein ensures that information about current and intended interrupt values, as well as packet statistics, are updated in a shared memory or available to shared devices through at least the accelerator driver. The accelerator driver is able to monitor and provide current interrupt values and packet statistics to the virtualizer interrupt moderation library to perform analysis for an intended interrupt value. This takes away from a need to periodically read values of parameters or to periodically read parameters in a data paths associated with where interrupt generation occurs. As the accelerator driver performs its monitoring in an accelerated data path, there is no (or substantially reduced) slowing or latency in the interrupt generation process.

Further, race conditions are resolved or addressed herein by preventing wrapping of indices associated with interrupt virtqueues. For example, the interrupt rate is monitored and adjusted dynamically through the accelerator driver coordinating between the virtualizer component and the accelerator device. This reduces false interrupts or prevents interrupts to be delayed. There is also no requirement for driver notifications from a driver to a device using the accelerator driver herein. This results in improved ability of the system 100 to handle outstanding inputs and outputs and reduces latency with respect to interrupt virtqueues. Further, interrupt moderation using an accelerator driver and an accelerator device is able to perform interrupt moderation without concern to VM drivers.

In at least one embodiment, the vIO IFs 110 are abstractions, such as virtual network devices, that are over devices in a virtualizer component 112. In at least one embodiment, one or more of the vIO IFs 110 may terminate within the accelerator device 118, as illustrated by the separate vIO IF 128. However, interrupts of such vIO Ifs 110, 128 may be monitored in a similar manner. The virtualizer component 112 may be a hypervisor or virtual machine manager (VMM) that is capable of supporting multiple virtual machines (VMs) 102. The vIO IFs 110, 128 may be in different data paths 130 between different VMs 102 and an accelerator device 118. The accelerator device 118 may be a PCI-enabled data-path accelerator. The data paths 130 may be subject to acceleration under a Virtio data path acceleration (vDPA) requirements of the Virtio standards.

Further, the vIO IFs 110 communicate with the VMs 102 using virtual input-output virtual machine interfaces (vIO VM IFs) 104 that are abstractly within respective VMs 102. The vIO VM IFs 104 are virtual network drivers, such as vDPA devices, in one example. The system 100 may include at least one circuit of a host machine to host a virtualizer component 112. The host machine can also host the VMs 102. The virtualizer component 112 can enable the different VMs 102 to be performed using the host machine and can handle interrupt communications. For instance, the virtualizer component 112 also includes an accelerator driver 114 and a virtualizer interrupt moderation library 116 to handle the interrupt communications. In one example, the virtualizer interrupt moderation library 116 is a Linux® Net DIM (Generic Network Dynamic Interrupt Moderation). The virtualizer interrupt moderation library 116 is able to function within a virtualizer component 112 to change a channel's interrupt moderation configuration. This may be performed to optimize packet processing.

The different VMs 102, being associated with respective vIO IFs 110, can communicate at least interrupts with the accelerator device 118. This communication may be through the accelerator driver 114 and the virtualizer interrupt moderation library 116. However, in at least one embodiment, one or more of the accelerator driver 114 and the virtualizer interrupt moderation library 116 may be used for monitoring and control aspects for a virtqueue(s) 120 associated with the accelerator device 118 and pertaining to the interrupts from the VMs 102. In an example, the accelerator driver 114 can monitor interrupts associated with the with the plurality of VMs 102. For example, the monitoring can include receiving interrupt information, such as, statistics provided from (or related to) the virtqueue(s) 120 of the accelerator device 118. The interrupt information may include at least a current interrupt value 122 and packet statistics 126. As used herein, a current interrupt value may include any appropriate interrupt or packet statistics that may be currently pertaining to interrupts associated with the accelerator device and the VMs. Therefore, even though recited in the singular, a current interrupt value can be one or more of at least one current interrupt rate, at least one current interrupt count, or at least one of other current interrupt packet statistics.

Further, the virtualizer interrupt moderation library 116 can use the current interrupt information and the packet statistics, as provided from the accelerator driver 114 that receives it from the accelerator device 118. The virtualizer interrupt moderation library 116 can determine an intended interrupt value 124 to be provided to the accelerator device 118 via the accelerator driver 114. As used herein, an intended interrupt value may include any appropriate interrupt or packet statistics that may be intended as pertaining to interrupts associated with the accelerator device and the VMs. Therefore, as in the case of the current interrupt value, even though recited in the singular, an intended interrupt value can be one or more of at least one intended interrupt rate, at least one intended interrupt count, or at least one of other intended interrupt packet statistics intended for an accelerator device. The intended interrupt value may be an increase or decrease of a number of interrupts held per time period in the virtqueue(s) 120, for instance. This increase or decrease may be indicative of an intended interrupt value 124, for instance. The virtualizer interrupt moderation library 116 can communicate the intended interrupt value 124 to the accelerator driver 114 and the accelerator driver 114 can provide the intended interrupt value 124 as a configuration to the accelerator device 118 to cause the accelerator device 118 to use the intended interrupt value 124 with interrupts from the different VMs 102.

Therefore, interrupt moderation for multiple VMs 102 can be a dynamic process that can be performed for different associated vIO IFs, including for legacy vIO IFs, using an accelerator driver 114 to issue commands between the virtualizer interrupt moderation library 116 and the accelerator device 118. The commands may include configuration to allow for monitoring of current interrupts and packet statistics, and allow for configuring the intended interrupts for the accelerator device 118.

In at least one embodiment, the interrupts are vDPA interrupts that may be provided in different approaches herein. For example, a driver may be provided to report the interrupts or information associated therewith, such as a current interrupt value and packet statistics, used by each virtqueue(s) 120, through a vDPA bus 132. In another example, the vDPA bus 132 may provide the interrupts or information associated therewith to the virtualizer component 112, where at least the interrupts are directed to a respective VM 102 and the information is directed to the virtualizer interrupt moderation library 116.

In at least one embodiment, the virtualizer component 112 may be a virtual machine emulator having different hardware and device capabilities for the VMs 102. The virtualizer component 112 may be performed on a host machine to present as a regular process for the host machine. The host machine may assign the virtualizer component 112 with process memory in which to allocate regions for the VMs 102 to use. Although this may be underlying physical memory, it is represented in the virtual form to the VMs 102 and the virtualizer component 112 is able to provide each of the VMs by executing instructions associated with processing for such VMs. In one example, the virtualizer component 112 may be QEMU® and an associated kernel based VMs 102 is a KVM. Further, the virtualizer component 112 is based on a Linux® kernel, in one example.

The virtualizer component 112 and the VMs 102 may perform input and output operations on bare metal of the host machine. This may include memory, processing, and networking operations. The virtualizer component 112 and the VMs 102 may perform such memory, processing, and networking operations by interfacing with mapped portions or entire ones of corresponding physical devices of the host machine. For example, access to a physical device of the host machine may be treated as a guest access and there may be memory regions, processing threads, and networking allotments to each of the VMs 102. Control during such operations may be transferred between the virtualizer component 112 and the host machine, as required, to enable transparent emulation for the VM, in at least one embodiment.

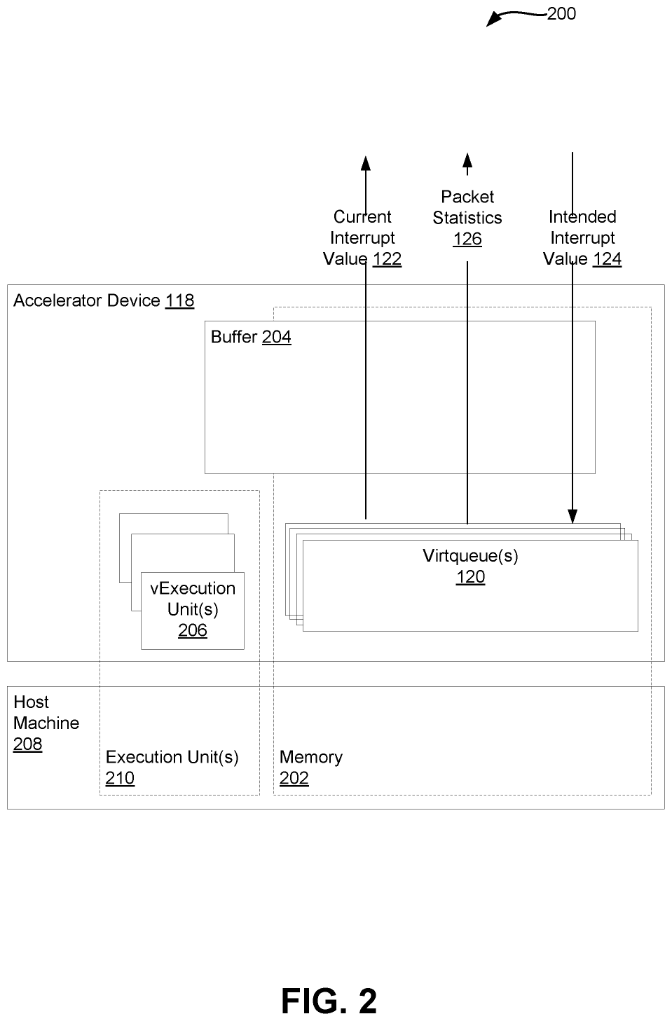

Each of the VMs 102 may be instantiated by the virtualizer component 112 to include virtual CPUs (vCPUs or vExecution unit(s) 206, in FIG. 2) that may be associated with one or more underlying processors (such as, CPUs, GPUs, or DPUs) of a host machine (such as, execution unit(s) 210 in host machine 208 of FIG. 2). This allows the processor to perform instructions as if it were native instructions. However, for interrupts from devices or special programs, a vCPU may be paused and information may be passed on to the virtualizer component 112 to instruct handling of the interrupt. Otherwise, the virtualizer component 112 allows all communication to the VMs 102.

In at least one embodiment, each of the vIO VM IFs 104 is a virtual network device, such as a virtual ethernet card. The vIO VM IFs 104 can supports multiple virtqueues that may be one or more of request virtqueues, control virtqueues, administration virtqueues, transmit virtqueues, or a receive virtqueues. For illustrative purposes, however, only transmit virtqueues TxQs 106 and receive virtqueues RxQs 108 are provided in FIG. 1. As these virtqueues are part of the virtqueues on the VM side, this has been marked by virtqueue 134 markings that are different from the virtqueue(s) 120 of the accelerator device 1118. Further, each of the virtqueues may be supported by respective (or shared) cache or buffers. Therefore, the system 100 herein may include multiple different virtqueues that support interrupts and that may also be associated with the transmit virtqueues TxQs 106, the receive virtqueues RxQs 108, or other virtqueues to perform interrupt functions. Further, packets that are incoming or outgoing may be queued into one virtqueue(s) 120 for communication. At least one of the virtqueue(s) 120 may be used for driver to device communication that may be in a control plane, such as to provide information about interrupts. Otherwise, at least one of the virtqueue(s) 120 may be used for data communication as part of a data plane. The information for control may also include filtering information using addresses, number of virtqueues, or other such relevant features.

As used herein, the virtual network devices vIO VM IFs 104 and the virtual network drivers vIO IFs 110 may be able to communicate as part of the virtualizer component 112 and by exposing the vIO VM IFs 104 to the VMs 102 through one or more transport methods, including using PCI or PCIe, for instance. At least the vIO VM IFs 104 are to represent physical devices to the VMs 102. For a communication, the vIO IFs 110 may communicate to the vIO VM IFs 104 though the provided transmitter and receiver virtqueues 106, 108, that may include one or more buffers. The buffers may retain metadata associated with communication for the packet. The buffers may also include a frame having the packet for communication. The vIO IFs 110 can also be associated with different or separated buffer having different entries under a metadata that may be associated with an incoming or outgoing communication session.

FIG. 2 is an illustration of further details 200 of a Virtio standard system for improving management of interrupt moderation for interrupts between circuits in a computing environment, in at least one embodiment. The accelerator device 118 may be a vDPA device that uses multiple data paths 130 for communication. The accelerator device 118 is supported by physical features on hardware of a host machine 208 and by emulated features supported by software, such as a kernel. The physical features may be provided, in part, by PCI or PCIe based devices of the host machine 208.

Further, if supported by PCI or PCIe based devices, the accelerator device 118 may be provided by a combination of one or more of a physical function (PF), a virtual function (VF) or other vendor specific provisions of the PF. Differently, however, the accelerator device 118 may be a non-PCI or PCIe device. In at least one embodiment, the accelerator device 118 may be emulated fully in software, such as, using the kernel. In an example, a virtual host subsystem of the kernel provides a data path 130. At least with respect to a host machine 208, the data path 130 may be emulated using the kernel, where application programming interfaces (APIs) may be provided for enabling the data path through virtual host subsystem.

In at least one embodiment, there may be buffers or portions therein, as allocated from the memory 202 of a host machine 208, to form part of the virtqueue(s) 120 may be used with the virtual network devices vIO VM IFs 104 and with the virtual network drivers vIO IFs 110. These buffers may be different than a buffer 204 that may be also from the memory 202 of the host machine 208 and that may be provided to retain information about the interrupt rates 122, 124, in at least one embodiment.

Further, the buffers forming part of the virtqueue(s) 120 may be managed by the virtual network drivers vIO IFs 110. The buffers or portions therein forming part of the virtqueue(s) 120 may be mapped to the virtual network devices vIO VM IFs 104. The virtualizer component accesses all the buffers or relevant areas of the memory 202 for reading or writing purposes, on behalf of the VMs 102 and one or more of the vExecution unit(s) 206. As illustrated, the virtqueue(s) 120 provides an approach for data communication on behalf of virtual network devices vIO VM IFs 104. Therefore, each of the virtual network devices vIO VM IFs 104 may have a virtqueue 120. The virtqueue(s) 120 may be part of allocated memory 202 of a host machine 208.

In addition, the separate buffer 204 may be associated with the allocated memory 202 for purposes of managing information associated with the interrupt rates 122, 124 and may be used to configure the virtqueue(s) 120. For example, the vExecution unit(s) 206 may perform the configuration based in part on the provided intended interrupt value 124 from the accelerator driver 114. In one approach, the intended interrupt value 124 may be used to adjust a size of one or more of the virtqueue(s) 120 to ensure that more or less interrupts can be buffered to match the intended interrupt value 124. Therefore, the accelerator device 118 may be associated with at least one virtqueue(s) 120 that may be subject to a change in its configuration. The change in configuration may be to enable the intended interrupt value 124 to be used with the interrupts instead of the current interrupt value 122.

In at least one embodiment, the accelerator device 118 retains information about the virtqueue(s) 120. Such information may include information about available buffers (to be used in processes of the VMs) and used buffers (having finished processes associated with the VMs). The information about the buffers may be shared to the virtualizer component 112 and the VMs 102 by writing to a specific memory address of the buffer 204, for instance. The vCPU can be used to provide interrupts to the VMs about the buffer information, in at least one example. In at least one embodiment, the information about the available buffers may also be indicative or representative of a current interrupt value 122, packet statistics 126, and of an intended interrupt value 124. For example, based in part on an intended interrupt value 124 and packet statistics 126 are received and retained in the buffer 204, the size of the virtqueue(s) 120 may be adjusted to match the requirement of the intended interrupt value 124. The size may be adjusted by allocations of the memory 202 performed by the accelerator device 118.

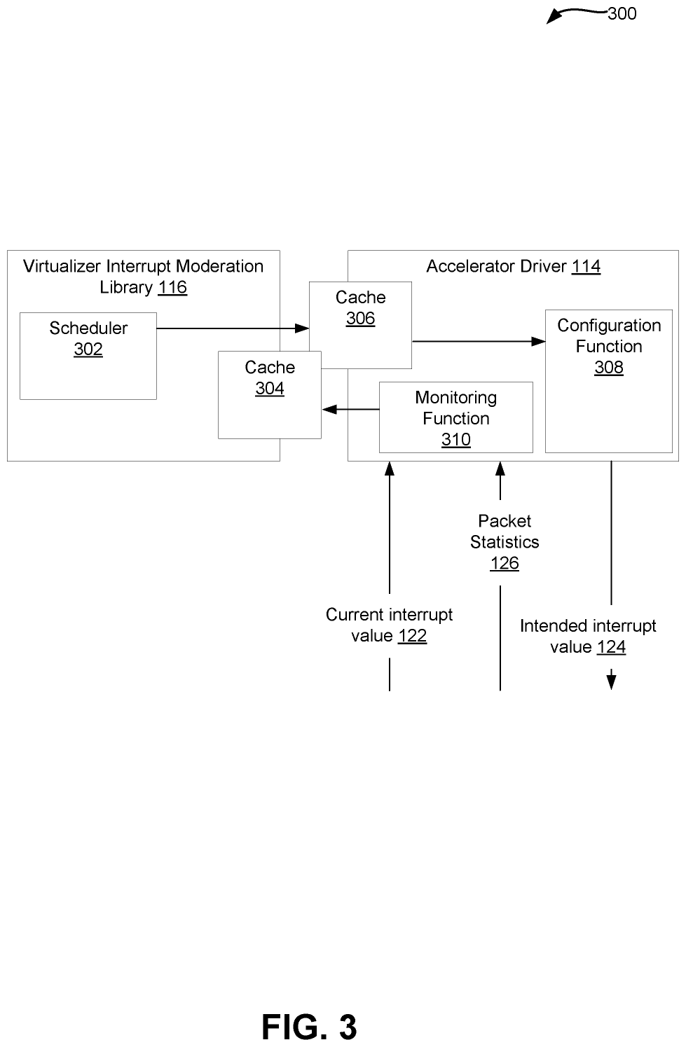

FIG. 3 is an illustration of details 300 of the virtualizer component in a Virtio standard system for improving management of interrupt moderation for interrupts between circuits in a computing environment, in at least one embodiment. The details 300 include the virtualizer interrupt moderation library 116 that may include one or more components 302 to perform scheduling towards an intended interrupt value 124 for the one or more virtqueue(s) 120. In one example, the virtualizer interrupt moderation library 116 is capable of dynamic interrupt moderation by communicating a configuration associated with an interrupt rate to an accelerator driver 114, which can use this information to configure one or more virtqueue(s) 120 of an accelerator device 118.

In at least one embodiment, the virtualizer interrupt moderation library 116 includes one or more algorithms executable through its kernel to determine a current interrupt value 122 and the packet statistics 126 based in part on information received to the accelerator driver 114. For example, extracting a format from the information may be associated with the determination aspect herein. Although the information is illustrated as having a current interrupt value 122 and packet statistics 126, the information may include a representation of a current interrupt value 122 and of packet statistics 126. The extraction from the presentation may be a derivation performed in part in the accelerator driver 114. In at least one embodiment, an algorithm of the virtualizer interrupt moderation library 116 may include an analysis on runtime interrupts, as sampled from the system 100. The algorithm may perform its analysis in an iterative manner. Further, the analysis may be performed after predetermined cycles or periods of operation of the system 100.

In at least one embodiment, the analysis by the algorithm may include a comparison of interrupt rates between cycles or periods to determine if a change is to be provided for the interrupt moderation herein. Therefore, the virtualizer interrupt moderation library 116 receives a current interrupt value 122 and packet statistics 126, and provides configuration for an intended interrupt value 124. In at least one embodiment, there may be associated caches 304, 306 that may be shared or distinct caches. The caches may store the interrupt rates as received from the virtualizer interrupt moderation library 116 or the accelerator driver 114 and can enable the algorithm to perform its analysis and its configuration.

In an example, a sample associated with an interrupt rate may include bandwidth information, a packet number, and an event number. In at least one embodiment, the virtualizer interrupt moderation library 116 is able to determine its own sample of interrupt data from a cache 304. The cache 304 may include a current interrupt value and packet statistics, as provided from a monitoring function 310 that monitors the incoming information or interrupt data from the accelerator device 118. Such incoming information may include the current interrupt value 122 and packet statistics 126 or a representation of the current interrupt value 122 and the packet statistics 126, which may be used to determine the current interrupt value and the packet statistics.

The virtualizer interrupt moderation library 116 is able to make its comparisons to prior samples of prior cycles or periods and is able to determine an interrupt moderation to be provided in a function using a scheduler 302. For example, the scheduler 302 can format and provide a configuration object to a cache 306. The configuration function 308 can then provide this configuration object as an intended interrupt value 124 to the accelerator device 118. The accelerator device 118 can buffer the configuration object in a buffer 204 before an execution unit, such as a vExecution unit(s) 206 applies it to at least one virtqueue(s) 120 by reconfiguring a size, for instance, of the at least one virtqueue(s) 120.

In at least one embodiment, the incoming information or interrupt data from the accelerator driver 114 are analyzed with similar incoming information or interrupt data from at least one prior cycle. This may be performed in an iteration process for every incoming information cycle. The analysis may be to optimize an interrupt rate associated with the system 100. A configuration object may be generated based in part on the analysis. A notification, such as the providing of the configuration object to the accelerator driver 114 may be performed to enable the accelerator driver 114 to communicate the configuration object as an intended interrupt value to the accelerator device 118. The accelerator device 114 may apply the intended interrupt value as described with respect to the use of the vExecution unit(s) 206, in at least one embodiment. Further, the scheduler 302 may be used to schedule the delivery of the configuration object to the accelerator driver 114.

Therefore, the accelerator driver 114 can provide the intended interrupt value in an interrupt rate configuration to the accelerator device 118. Then, the accelerator device 118 can configure at least one virtqueue(s) 120 therein or associated therewith, in accordance with the intended interrupt value. Further, the respective vIO IFs 110 herein may be enabled for one or more of a receiver or a transmit virtqueues based interrupt moderation. For example, the accelerator device and accelerator driver herein enable interrupt moderation that is from a device side or a driver side. When a driver, such as one belonging to a VM 102, wants to post packages, it may try to moderate notifications from the driver, representing a complex device scheme. Herein, however, VM drivers may communicate to the accelerator driver that performs the monitoring and handling of interrupt rates for the kernel and for the accelerator devices associated with the virtqueues. This process enables better CPU implementation and utilization. As such, when packet traffic is low, it is worth to interrupt the CPU and the interrupt rate may be determined dynamically to enable a balance between the CPU utilization and interrupt requirements.

While interrupt moderation may include reads, such as PCI reads from a device side, and may involve a device notifying about an interrupt, these requirements may cross the PCI or other communication bus to cause the read for some values from the posting of a packet. These may be high latency processes; however, using the accelerator driver and the accelerator device herein, it is possible to handle interrupt moderation requirements from both sides via at least the accelerator device than monitors current interrupt values and the packet statistics, and provides intended interrupt values. The latency in the system 100 herein is a software latency that is an improvement over prior latency and may be in the range of about 2 nanoseconds or less. The use of the accelerator driver and the accelerator device provides a light interface of the accelerator driver that feeds data to the virtualizer interrupt moderation library and that gets decisions there from to slow down or speed up an interrupt rate. The accelerator driver can send commands to a PCI or other bus or device to reduce or increase an interrupt rate.

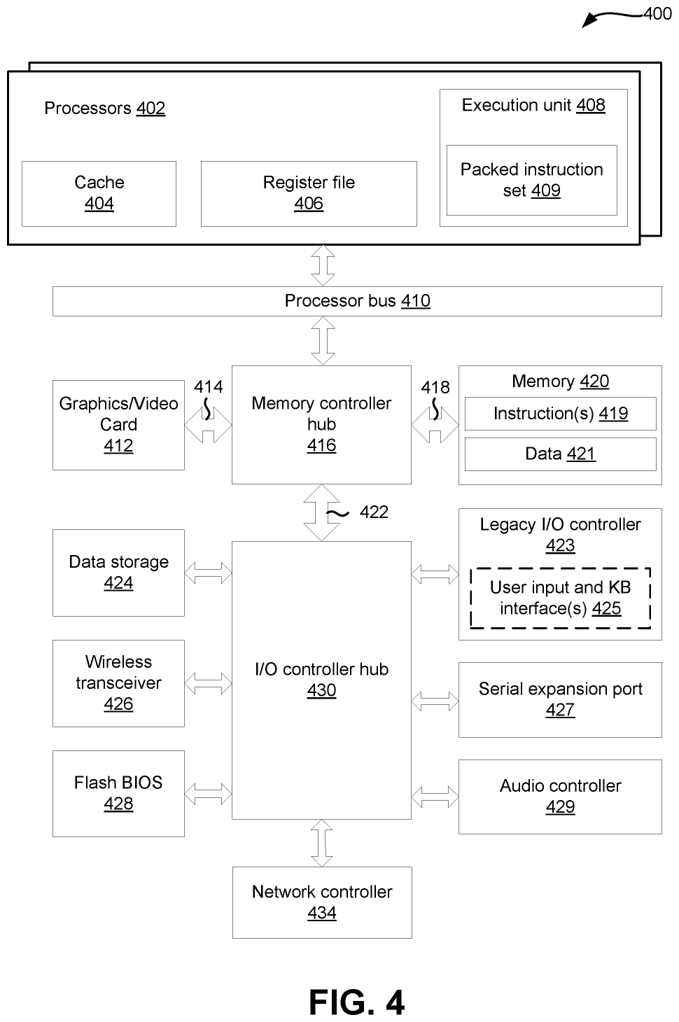

FIG. 4 illustrates computer and processor aspects 400 of a Virtio standard system for improving management of interrupt moderation for interrupts between circuits in a computing environment, in at least one embodiment. For example, each of the illustrated processors 402 may include one or more processing or execution units 408 that can perform any or all of the aspects of the system 100 for improving management of interrupt moderation for interrupts between circuits in a computing environment. The system 100 may include the one or more processing or execution units 408 in one or more host machines in a computing environment.

The processing or execution units 408 may include multiple circuits to support the aspects described herein for one or more of the accelerator driver 114, the virtualizer interrupt moderation library 116, the accelerator device 118. In at least one embodiment, the processors herein may include CPUs, GPUs, DPUs that may be associated with a multi-tenant environment to perform one or more of the accelerator driver 114, the virtualizer interrupt moderation library 116, the accelerator device 118 described herein. Further, the GPUs may be distinctly in distinct graphics/video cards 412, relative to a DPU (represented by a network controller 434) and a CPU represented by the processors 402 illustrated in FIG. 4. Therefore, even though described in the singular, the graphics/video card 412 may include multiple cards and may include multiple GPUs on each card.

The computer and processor aspects 400 may be performed by one or more processors 402 that include a system-on-a-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processors 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processors 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414. In at least one embodiment, the graphics/video card 412 may be coupled to one or more of the processors 402 via a PCIe interconnect standard. Similarly, a network controller 424 may also be coupled to one or more of the processors 402 via a PCIe interconnect standard.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processors 402. Examples may include, without limitation, an audio controller 429, a firmware hub (“flash BIOS”) 428, a wireless transceiver 426, a data storage 424, a legacy I/O controller 423 containing user input and keyboard interface(s) 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

Therefore, the at least one execution unit 408 may be a circuit of at least one processor 402 to be associated with at least one accelerator device. The at least one accelerator device is adapted for data path acceleration with respective vIO IFs of different VMs. The at least one accelerator device is also adapted to communicate a current interrupt value and packet statistics with an accelerator driver of a virtualizer component of at least one host machine. The at least one accelerator device is also adapted to receive an intended interrupt value as determined by a virtualizer interrupt moderation library based in part on the current interrupt value and the packet statistics. The intended interrupt value is to be used with interrupts of the at least one accelerator device and with at least one of the different VMs.

The at least one accelerator device may be a PCI-enabled data-path accelerator. Therefore, the at least one execution unit 408 may be a circuit of at least one processor 402, which is capable of PCI or PCIe communications. Further, the accelerator driver may also be associated with the at least one execution unit 408 to provide the intended interrupt value in an interrupt rate configuration to the accelerator device. For example, the accelerator driver may be performed by a virtualizer component using underlying hardware or physical resources of a host machine. The accelerator device can then configure at least one virtqueue therein in accordance with the intended interrupt value.

In at least one embodiment, one or more of the accelerator driver or the accelerator device is stateless feature of the system 100. The stateless feature enables one or more of the accelerator device or the accelerator driver to be agnostic to a state of the interrupts associated therewith. Further, the stateless feature enables the accelerator driver or the accelerator device to remain devoid of storage of a relationship of an interrupt rate, a packet rate from the current interrupt value and the packet statistics. As such, the relationship of the interrupt rate and the packet rate is onloaded to the virtualizer interrupt moderation library. The accelerator device may also be adapted to provide information about the interrupts to enable the accelerator driver to perform the monitoring of the interrupts associated with the accelerator device.

Further, the at least one execution unit 408 may be a circuit of at least one processor 402 to be associated with at least one virtualizer component of at least one host machine. The at least one virtualizer component can include an accelerator driver and can include different vIO IFs of different VMs. The accelerator driver can receive a current interrupt value and packet statistics from an accelerator device and can communicate an intended interrupt value that is based in part on the current interrupt value and the packet statistics to the accelerator device. The intended interrupt value can be determined by a virtualizer interrupt moderation library of the at least one virtualizer component, based in part on the discussion with respect to FIG. 3, in at least one example. The at least one virtualizer component is in communication with the accelerator driver to provide the intended interrupt value to the accelerator drive, which can then provide it to the accelerator device. The intended interrupt value can be used by the at least one accelerator device and can be used with interrupts of the at least one accelerator device and with at least one of the different VMs.

In at least one embodiment, the at least one virtualizer component is a hypervisor for the different VMs and the at least one host machine also includes the different VMs. However, the at least one virtualizer component and the different VMs may be provided using multiple host machines that share one or more of networking, memory, and processing aspects of a system for improving management of interrupt moderation for interrupts between circuits in a computing environment. The at least one virtualizer component may also include a configuration function, as detailed in at least FIG. 4. The configuration function can communicate the intended interrupt value as a configuration to the accelerator device. This can enable the accelerator device to use at least one virtqueue therein in accordance with the intended interrupt value.

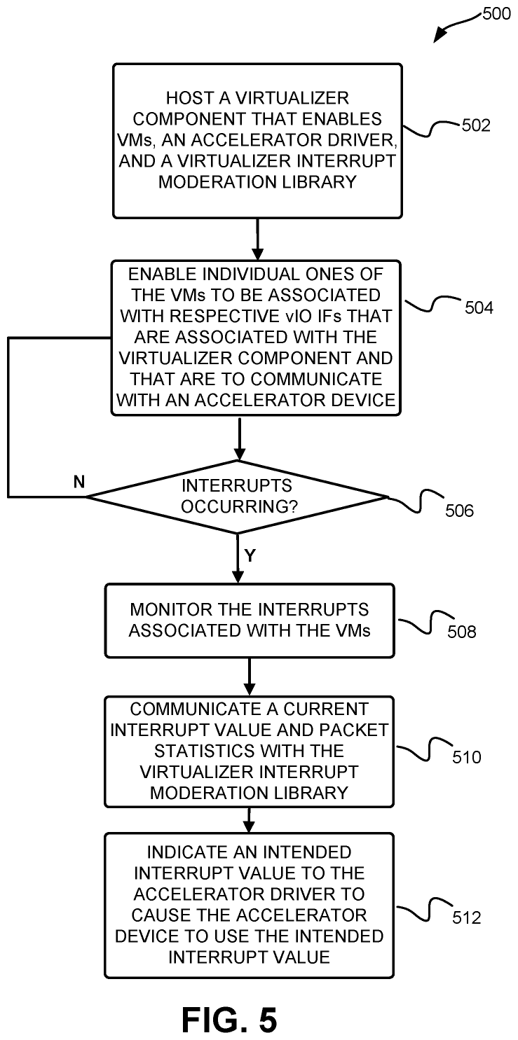

FIG. 5 illustrates a process flow or method 500 for a Virtio standard system for improving management of interrupt moderation for interrupts between circuits in a computing environment, in at least one embodiment. The method 500 includes hosting 502, using at least one host machine, a virtualizer component, an accelerator driver, and a virtualizer interrupt moderation library. The virtualizer component may be one that enables multiple VMs, in at least one embodiment. The method includes enabling 504 individual ones of the VMs to be associated with respective vIO IFs that are associated with the virtualizer component and that are to communicate with an accelerator device. A verification 506 may be performed to ensure that interrupts are occurring. For example, one or more virtqueues may build an interrupt stack based in part on incoming interrupts, which may be a basis of the verification 506. Further, interrupts may be received in the virtualizer component and may be a basis of the verification 506.

The method 500 includes monitoring 508 the interrupts associated with the accelerator device using the accelerator driver. The monitoring 508 may include receiving interrupt information, such as, statistics provided from (or related to) a virtqueue of an accelerator device. The interrupt information may include a current interrupt value and packet statistics. The monitoring 508 may include determining that at least the current interrupt value and the packet statistics is present in the incoming information or interrupt data, from the accelerator device. For example, the monitoring 508 may include extracting and preparing to communicate the current interrupt value and the packet statistics to a virtualizer interrupt moderation library. In at least one embodiment, the preparing part may include formatting the current interrupt value and the packet statistics to a format acceptable to the virtualizer interrupt moderation library.

The method 500 includes communicating 510 the current interrupt value and the packet statistics with the virtualizer interrupt moderation library. The virtualizer interrupt moderation library can use the current interrupt value and the packet statistics to determine an intended interrupt value for the accelerator device. This can be a comparison process to prior current interrupt values in prior cycles or periods of an interactive process, as described in part with respect to one or more of FIGS. 1-4. The virtualizer interrupt moderation library can indicate 512 the intended interrupt value to the accelerator driver. As part of the indication 512, the intended interrupt value itself may be communicated to the accelerator driver. The accelerator driver can then communicate the intended interrupt value to the accelerator device. For example, the accelerator driver can communicate the intended interrupt value to be buffered and configured in the accelerator device. The accelerator device can be caused to use the intended interrupt value with at least one of the plurality of VMs. For example, a vExecution unit of the accelerator device may be used to perform the configuration of one or more virtqueues of the accelerator device to be able to provide interrupts at an interrupt rate that is consistent with the intended interrupt value. In one approach, the intended interrupt value may be used to adjust a size of one or more of the virtqueues to ensure that more or less interrupts can be buffered to match the intended interrupt value.

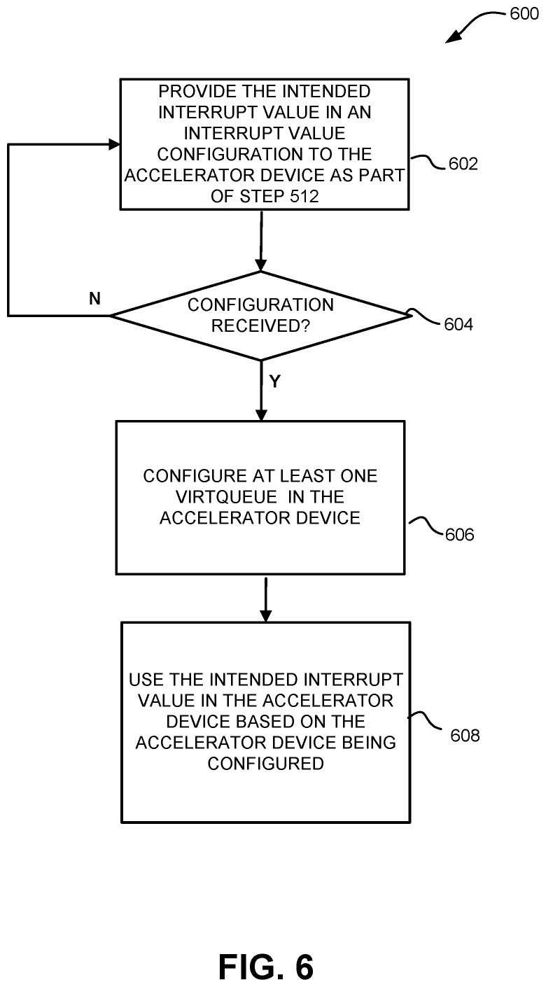

FIG. 6 illustrates another process flow or method 600 for a Virtio standard system for improving management of interrupt moderation for interrupts between circuits in a computing environment, in at least one embodiment. The method 600 may be used in conjunction with the method 500 of FIG. 5, in at least one embodiment. The method 600 in FIG. 6 includes providing 602, by the accelerator driver, the intended interrupt value in an interrupt rate configuration to the accelerator device. This may be in support of step 512 of FIG. 5. The method 600 includes verifying 604 that the interrupt rate configuration is received and that it requires adjustments to one or more virtqueues of the accelerator device. The method 600 includes configuring 606, in the accelerator device, at least one virtqueue in accordance with the intended interrupt value. This may also be in support of step 512 of FIG. 5. The method 600 includes using 608 the intended interrupt value in the accelerator device based on the accelerator device being configured by the interrupt rate configuration.

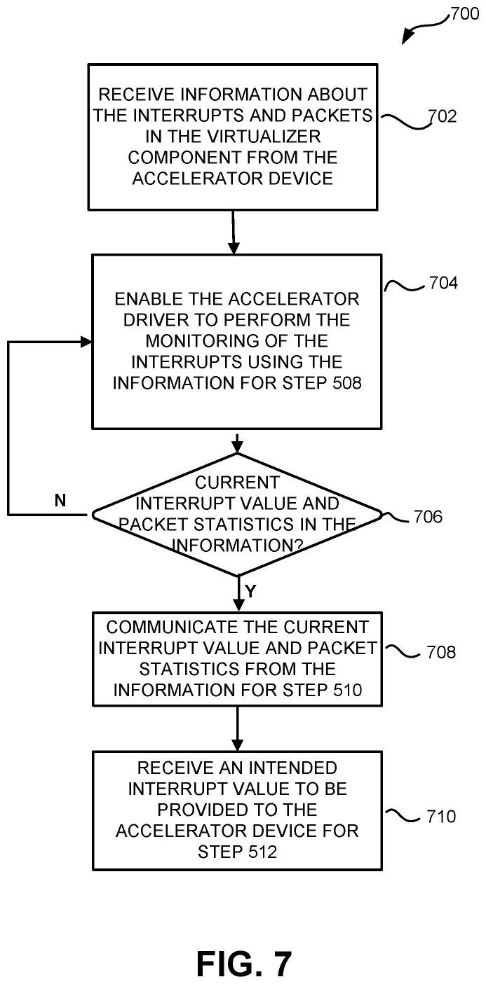

FIG. 7 illustrates yet another process flow or method 700 for a Virtio standard system for improving management of interrupt moderation for interrupts between circuits in a computing environment, in at least one embodiment. The method 700 may be used in conjunction with one or more of the methods 500, 600 of FIGS. 5 and 6, in at least one embodiment. The method 700 in FIG. 7 may be performed wholly by an accelerator driver of a virtualizer component. For example, the method 700 includes receiving 702 information about the interrupts in the virtualizer component from the accelerator device. The method 700 includes enabling 704 the accelerator driver to perform the monitoring of the interrupts using the information, as in step 508 of FIG. 5. The method 700 includes verifying 706 that a current interrupt value and that packet statistics are in the information. The method 700 includes communicating 708 the current interrupt value and the packet statistics from the information. This may be in support of step 510 of FIG. 5 and the communication may be from the accelerator driver to the virtualizer interrupt moderation library. This allows the virtualizer interrupt moderation library to perform its analysis in a cycle or periodic manner to provide an intended interrupt value for the accelerator device. The virtualizer interrupt moderation library provides the intended interrupt value to the accelerator driver. Therefore, the method 700, from the perspective of the accelerator driver, receives 710 the intended interrupt value to be provided to the accelerator device in support of step 512 of FIG. 5.

In at least one embodiment, the methods 500-700 herein are such that the accelerator driver is a stateless feature. The stateless feature enables one or more of the accelerator device or the accelerator driver to be agnostic to a state of the interrupts associated therewith. Further, the stateless feature enables the accelerator driver or the accelerator device to remain devoid of storage of a relationship of an interrupt rate, a packet rate from the current interrupt value and the packet statistics. As such, the relationship of the interrupt rate and the packet rate is onloaded to the virtualizer interrupt moderation library. In one example, the state of the interrupts may be associated with an interrupt rate of the interrupts or the relationship of the interrupt rate and the packet rate. The accelerator driver monitors and communicates at least the current interrupt value and the packet statistics to the virtualizer interrupt moderation library and need not retain the state of the interrupts, including the relationship. Instead, the virtualizer interrupt moderation library is onloaded with this information and performs its analysis, including a comparison in a period or cycle of different interrupt rates, to determine to adjust a current interrupt value, for instance.

In at least one embodiment, the methods 500-700 herein may include a further step or sub-step of providing, by the accelerator device and to the accelerator driver, information about the interrupts to enable the accelerator driver to perform the monitoring of the interrupts using the information. The methods 500-700 herein may include a further step or sub-step of providing the virtualizer component as a hypervisor or a virtual machine manager for the VMs. The methods 500-700 herein may include a further step or sub-step of enabling the hypervisor or the virtual machine manager to be part of at least one host machine.

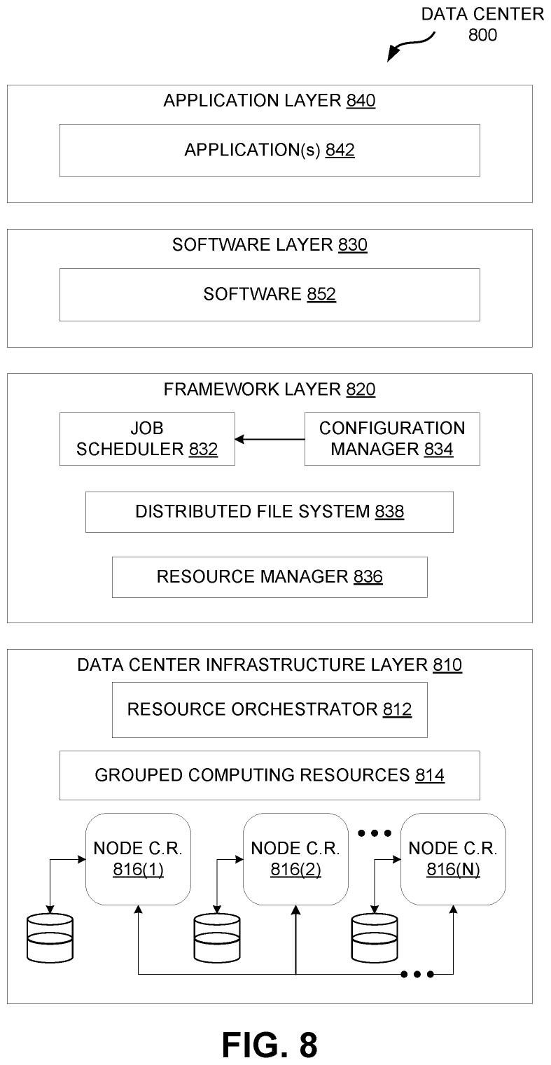

FIG. 8 illustrates an exemplary data center 800 and associated aspects to be used with a Virtio standard in improving management of interrupt moderation for interrupts between circuits in a computing environment, in accordance with at least one embodiment. In at least one embodiment, the data center 800 includes, without limitation, a data center infrastructure layer 810, a framework layer 820, a software layer 830 and an application layer 840, to perform aspects according to techniques described with respect to at least one or more of FIGS. 1-3 and 5-7 herein.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, VMs, power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes, without limitation, a job scheduler 832, a configuration manager 834, a resource manager 836 and a distributed file system 838. In at least one embodiment, framework layer 820 may include a framework to support software 852 of software layer 830 and/or one or more application(s) 842 of application layer 840. In at least one embodiment, software 852 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820, including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resources 814 at data center infrastructure layer 810. In at least one embodiment, resource manager 836 may coordinate with resource orchestrator 812 to manage these mapped or allocated computing resources.

In at least one embodiment, software 852 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. In at least one or more types of applications may include, without limitation, CUDA applications.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, associated aspects of the data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

FIG. 8 also set forth, without limitation, exemplary computer-based systems that form associated aspects that can be used with the data center 800 to implement at least one embodiment. For example, the data center 800 includes a processing system, in accordance with at least one embodiment. In at least one embodiment, the processing system may include one or more processor(s) and one or more graphics processor(s), and may be a single processor desktop system, a multiprocessor workstation system, or a server system having a large number of processor(s) or processor core(s). In at least one embodiment, the processing system is a processing platform incorporated within a system-on-a-chip (“SoC”) integrated circuit for use in mobile, handheld, or embedded devices.

In at least one embodiment, the processing system can include, or be incorporated within a server-based gaming platform, a game console, a media console, a mobile gaming console, a handheld game console, or an online game console. In at least one embodiment, the processing system is a mobile phone, smart phone, tablet computing device or mobile Internet device. In at least one embodiment, the processing system can also include, coupled with, or be integrated within a wearable device, such as a smart watch wearable device, smart eyewear device, augmented reality device, or virtual reality device. In at least one embodiment, the processing system is a television or set top box device having one or more processor(s) and a graphical interface generated by one or more graphics processor(s).

In at least one embodiment, the one or more processor(s) each include one or more processor core(s) to process instructions which, when executed, perform operations for system and user software. In at least one embodiment, each of one or more processor core(s) is configured to process a specific instruction set. In at least one embodiment, an instruction set may facilitate Complex Instruction Set Computing (“CISC”), Reduced Instruction Set Computing (“RISC”), or computing via a Very Long Instruction Word (“VLIW”). In at least one embodiment, the processor core(s) may each process a different instruction set, which may include instructions to facilitate emulation of other instruction sets. In at least one embodiment, the processor core(s) may also include other processing devices, such as a digital signal processor (“DSP”).

In at least one embodiment, the processor(s) includes cache memory (“cache”). In at least one embodiment, processor(s) can have a single internal cache or multiple levels of internal cache. In at least one embodiment, cache memory is shared among various components of processor(s). In at least one embodiment, the processor(s) also uses an external cache (e.g., a Level 3 (“L3”) cache or Last Level Cache (“LLC”)) (not shown), which may be shared among processor core(s) using known cache coherency techniques. In at least one embodiment, the register file is additionally included in processor(s) which may include different types of registers for storing different types of data (e.g., integer registers, floating point registers, status registers, and an instruction pointer register). In at least one embodiment, the register file may include general-purpose registers or other registers.

In at least one embodiment, the one or more processor(s) are coupled with one or more interface bus(es) to transmit communication signals such as address, data, or control signals between processor(s) and other components in the processing system. In at least one embodiment interface bus(es) can be a processor bus, such as a version of a Direct Media Interface (“DMI”) bus. In at least one embodiment, the interface bus(es) is not limited to a DMI bus, and may include one or more of the Peripheral Component Interconnect buses (e.g., “PCI,” PCI Express (“PCIe”)), memory buses, or other types of interface buses. In at least one embodiment, the processor(s) include an integrated memory controller and a platform controller hub. In at least one embodiment, memory controller facilitates communication between a memory device and other components of the processing system, while a platform controller hub (“PCH”) provides connections to Input/Output (“I/O”) devices via a local I/O bus.

In at least one embodiment, the memory device herein can be a dynamic random access memory (“DRAM”) device, a static random access memory (“SRAM”) device, flash memory device, phase-change memory device, or some other memory device having suitable performance to serve as processor memory. In at least one embodiment, the memory device can operate as system memory for the processing system, to store data and instructions for use when one or more processor(s) executes an application or process. In at least one embodiment, the memory controller also couples with an optional external graphics processor, which may communicate with one or more graphics processor(s) in processor(s) to perform graphics and media operations. In at least one embodiment, a display device can connect to the processor(s). In at least one embodiment the display device can include one or more of an internal display device, as in a mobile electronic device or a laptop device or an external display device attached via a display interface (e.g., DisplayPort, etc.). In at least one embodiment, the display device can include a head mounted display (“HMD”) such as a stereoscopic display device for use in virtual reality (“VR”) applications or augmented reality (“AR”) applications.

In at least one embodiment, a platform controller hub enables peripherals to connect to the memory device and the processor(s) via a high-speed I/O bus. In at least one embodiment, the I/O peripherals include, but are not limited to, an audio controller, a network controller, a firmware interface, a wireless transceiver, touch sensors, a data storage device (e.g., hard disk drive, flash memory, etc.). In at least one embodiment, a data storage device can connect via a storage interface (e.g., SATA) or via a peripheral bus, such as PCI, or PCIe. In at least one embodiment, touch sensors can include touch screen sensors, pressure sensors, or fingerprint sensors. In at least one embodiment, a wireless transceiver can be a Wi-Fi transceiver, a Bluetooth transceiver, or a mobile network transceiver such as a 3G, 4G, or Long Term Evolution (“LTE”) transceiver. In at least one embodiment, firmware interface enables communication with system firmware, and can be, for example, a unified extensible firmware interface (“UEFI”). In at least one embodiment, a network controller can enable a network connection to a wired network. In at least one embodiment, a high-performance network controller couples with interface bus(es). In at least one embodiment, an audio controller is a multi-channel high definition audio controller. In at least one embodiment, the processing system includes an optional legacy I/O controller for coupling legacy (e.g., Personal System 2 (“PS/2”)) devices to processing system. In at least one embodiment, a platform controller hub can also connect to one or more Universal Serial Bus (“USB”) controller(s) connect input devices, such as a keyboard and mouse combinations, a camera, or other USB input devices.

In at least one embodiment, an instance of memory controller and a platform controller hub may be integrated into a discreet external graphics processor, such as external graphics processor. In at least one embodiment, a platform controller hub and/or a memory controller may be external to one or more processor(s). For example, in at least one embodiment, the processing system can include an external memory controller and a platform controller hub, which may be configured as a memory controller hub and a peripheral controller hub within a system chipset that is in communication with processor(s). In at least one embodiment, the system herein is an electronic device that utilizes a processor. In at least one embodiment, the system herein may be, for example and without limitation, a notebook, a tower server, a rack server, a blade server, a laptop, a desktop, a tablet, a mobile device, a phone, an embedded computer, or any other suitable electronic device.

In at least one embodiment, the system herein may include, without limitation, processor communicatively coupled to any suitable number or kind of components, peripherals, modules, or devices. In at least one embodiment, a processor herein is coupled using a bus or interface, such as an I2C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, the FIGS. herein illustrate a system which includes interconnected hardware devices or “chips.” In at least one embodiment, the FIGS. herein may illustrate an exemplary SoC. In at least one embodiment, devices illustrated herein may be interconnected with proprietary interconnects, standardized interconnects (e.g., PCIe) or some combination thereof. In at least one embodiment, one or more components of the figures herein are interconnected using CXL interconnects.

In at least one embodiment, the FIGS. herein may include a display, a touch screen, a touch pad, a Near Field Communications unit (“NFC”), a sensor hub, a thermal sensor, an Express Chipset (“EC”), a Trusted Platform Module (“TPM”), BIOS/firmware/flash memory (“BIOS, FW Flash”), a DSP, a Solid State Disk (“SSD”) or Hard Disk Drive (“HDD”), a wireless local area network unit (“WLAN”), a Bluetooth unit, a Wireless Wide Area Network unit (“WWAN”), a Global Positioning System (“GPS”), a camera (“USB 3.0 camera”) such as a USB 3.0 camera, or a Low Power Double Data Rate (“LPDDR”) memory unit (“LPDDR3”) implemented in, for example, LPDDR3 standard. These components may each be implemented in any suitable manner.

In at least one embodiment, other components may be communicatively coupled to the processor herein through components discussed above. In at least one embodiment, an accelerometer, an Ambient Light Sensor (“ALS”), a compass, and a gyroscope may be communicatively coupled to a sensor hub. In at least one embodiment, a thermal sensor, a fan, a keyboard, and a touch pad may be communicatively coupled to an EC. In at least one embodiment, a speakers, a headphones, and a microphone (“mic”) may be communicatively coupled to an audio unit (“audio codec and class d amp”), which may in turn be communicatively coupled to DSP. In at least one embodiment, an audio unit may include, for example and without limitation, an audio coder/decoder (“codec”) and a class D amplifier. In at least one embodiment, a SIM card (“SIM”) may be communicatively coupled to a WWAN unit. In at least one embodiment, components such as WLAN unit and Bluetooth unit 1052, as well as WWAN unit may be implemented in a Next Generation Form Factor (“NGFF”).

In the following description, numerous specific details are set forth to provide a more thorough understanding of at least one embodiment. However, it will be apparent to one skilled in the art that the inventive concepts may be practiced without one or more of these specific details.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A Virtio standard system comprising at least one circuit to host a virtualizer component that enables a plurality of virtual machines (VMs), an accelerator driver, and a virtualizer interrupt moderation library, wherein individual ones of the plurality of VMs are associated with respective virtual input-output interfaces (vIO IFs) that are associated with the virtualizer component and that are to communicate with an accelerator device, wherein the accelerator driver is to monitor interrupts associated with the plurality of VMs and to communicate a current interrupt value and packet statistics with the virtualizer interrupt moderation library, and wherein the virtualizer interrupt moderation library is to indicate an intended interrupt value to the accelerator driver to cause the accelerator device to use the intended interrupt value with at least one of the plurality of VMs.

2. The Virtio standard system of claim 1, wherein the accelerator device is a peripheral component interconnect (PCI)-enabled data-path accelerator.

3. The Virtio standard system of claim 1, wherein the accelerator driver is to provide the intended interrupt value in an interrupt rate configuration to the accelerator device and wherein the accelerator device is to configure at least one virtqueue therein in accordance with the intended interrupt value.

4. The Virtio standard system of claim 1, wherein the respective vIO IFs are virtqueues that comprise one or more of request virtqueues, control virtqueues, administration virtqueues, receive virtqueues, or transmit virtqueues.

5. The Virtio standard system of claim 1, wherein one or more of the accelerator driver or the accelerator device is a stateless feature the system, wherein the stateless feature enables one or more of the accelerator driver or the accelerator device to be agnostic to a state of the interrupts associated therewith, wherein the stateless feature enables the accelerator driver or the accelerator device to remain devoid of storage of a relationship of an interrupt rate and a packet rate from the current interrupt value and the packet statistics, and wherein the relationship of the interrupt rate and the packet rate is onloaded to the virtualizer interrupt moderation library.

6. The Virtio standard system of claim 1, wherein the accelerator device is adapted to provide information about the interrupts to enable the accelerator driver to perform the monitoring of the interrupts associated with the accelerator device.

7. The Virtio standard system of claim 1, wherein the virtualizer component is a hypervisor or a virtual machine manager for the plurality of VMs and wherein the at least one circuit is part of at least one host machine that also includes the plurality of VMs.

8. At least one Virtio standard accelerator device adapted for data path acceleration with respective virtual input-output interfaces (vIO IFs) associated with different virtual machines (VMs), adapted to communicate a current interrupt value and packet statistics with an accelerator driver of a virtualizer component of at least one host machine, and adapted to receive an intended interrupt value as determined by a virtualizer interrupt moderation library based in part on the current interrupt value and the packet statistics, wherein the intended interrupt value is to be used with interrupts of the at least one Virtio standard accelerator device and with at least one of the different VMs.

9. The at least one Virtio standard accelerator device claim 8, wherein the at least one accelerator device is a peripheral component interconnect (PCI)-enabled data-path accelerator.

10. The at least one Virtio standard accelerator device claim 8, wherein the accelerator driver is to provide the intended interrupt value in an interrupt rate configuration to the accelerator device and wherein the accelerator device is to configure at least one virtqueue therein in accordance with the intended interrupt value.

11. The at least Virtio standard one accelerator device claim 8, wherein one or more of the accelerator driver or the accelerator device is a stateless feature the system, wherein the stateless feature enables one or more of the accelerator driver or the accelerator device to be agnostic to a state of the interrupts associated therewith.

12. The at least one Virtio standard accelerator device claim 8, wherein the at least one accelerator device is associated with a virtqueue that is subject to a change in configuration, the change in configuration to enable the intended interrupt value to be used with the interrupts instead of the current interrupt value.

13. At least one Virtio standard virtualizer component of at least one host machine to comprise an accelerator driver and to comprise different virtual input-output interfaces (vIO IFs) that are associated with different virtual machines (VMs), the accelerator driver to receive a current interrupt value and packet statistics from an accelerator device, and to communicate an intended interrupt value that is based in part on the current interrupt value and the packet statistics to the accelerator device, the intended interrupt value determined by a virtualizer interrupt moderation library of the at least one Virtio standard virtualizer component that is in communication with the accelerator driver, the intended interrupt value to be used with interrupts of the at least one accelerator device and with at least one of the different VMs.

14. The at least one Virtio standard virtualizer component of claim 13, wherein the at least one virtualizer component is a hypervisor or a virtual machine manager for the different VMs and wherein the at least one host machine also includes the different VMs.

15. The at least one Virtio standard virtualizer component of claim 13, wherein the at least one virtualizer component comprises a configuration function, the configuration function to communicate the intended interrupt value as a configuration to the accelerator device to enable the accelerator device to use at least one virtqueue therein in accordance with the intended interrupt value.

16. A method for handling interrupts in a Virtio standard, the method comprising:
hosting, using at least one host machine, a virtualizer component that enables a plurality of virtual machines (VMs), an accelerator driver, and a virtualizer interrupt moderation library;
enabling individual ones of the plurality of VMs to be associated with respective virtual input-output interfaces (vIO IFs) that are associated with the virtualizer component and that are to communicate with an accelerator device;
monitoring, using the accelerator driver, interrupts associated with the accelerator device; and
communicating a current interrupt value and packet statistics with the virtualizer interrupt moderation library, wherein the virtualizer interrupt moderation library is to indicate an intended interrupt value to the accelerator driver to cause the accelerator device to use the intended interrupt value with at least one of the plurality of VMs.

17. The method of claim 16, further comprising:
providing, by the accelerator driver, the intended interrupt value in an interrupt rate configuration to the accelerator device; and
configuring, in the accelerator device, at least one virtqueue in accordance with the intended interrupt value.

18. The method of claim 16, wherein one or more of the accelerator driver or the accelerator device is a stateless feature the system, wherein the stateless feature enables one or more of the accelerator driver or the accelerator device to be agnostic to a state of the interrupts associated therewith.

19. The method of claim 16, further comprising:
providing, by the accelerator device, information about the interrupts; and
enabling the accelerator driver to perform the monitoring of the interrupts using the information.

20. The method of claim 16, further comprising:
providing the virtualizer component as a hypervisor or a virtual machine manager for the plurality of VMs; and
enabling the hypervisor or the virtual machine manager to be part of at least one host machine.
